(19) United States
(12) Patent Application Publication
(10) Pub. No.: US 2008/0007910 A1
(43) Pub. Date: Jan. 10, 2008

(54) Storage-type heat-dissipating pad of notebook computer

(76) Inventor: Cheng-I Lin, Taoyuan (TW)

Correspondence Address: TROXELL LAW OFFICE PLLC, Suite 1404, 5205 Leesburg Pike, Falls Church, VA, 22041, US

(21) Appl. No.: 11/482,741

(22) Filed: Jul. 10, 2006

(51) Int. Cl. G06F 1/20

(52) U.S. Cl. 361/687

(57) ABSTRACT

A storage-type heat-dissipating pad of a notebook computer comprises a storage body and a heat-dissipating body. The storage body comprises a cover and a storage base for storing computer peripherals. The storage body is coupled with the heat-dissipating body. The heat-dissipating body comprises a shell and a fan unit. When in use, the notebook computer is disposed on the heat-dissipating body for heat dissipation. As a result, the storage-type heat-dissipating pad is easy to store and convenient to carry and complies with human engineering.

### FIELD OF THE INVENTION

The present invention relates to a storage-type heat-dissipating pad of a notebook computer, and more particularly to a storage-type heat-dissipating pad having a storage body for storing computer peripherals and a heat-dissipating body for heat dissipation, thereby providing the advantages of easy storage, convenient carriage and complying with human engineering.

### BACKGROUND OF THE INVENTION

Generally speaking, the surface temperature of the general notebook computer is about 31 degrees Celsius when it is initially started up. After one hour, the surface temperature is raised up to 40 degrees Celsius. After a period of time, the interior temperature of the notebook computer is larger than 70 degrees Celsius. Therefore, for the purpose of dissipating more heat, a heat-dissipating pad is usually disposed under the notebook computer for heat-dissipation.

The frequently seen heat-dissipating pad usually has a certain thickness and a flat case having several fans disposed therein. When in use, the notebook computer (shown in FIG. 1) is disposed on the case, and the air inside the case is exchanged with the air outside the case for reducing the interior temperature of the case.

However, when the aforesaid heat-dissipating pad is put to practical use, it causes the defects as follows: (1) The heat-dissipating pad is uneasy to carry since it has a certain thickness and is not compliable with other computer peripherals; (2) The notebook computer, which is disposed on the heat-dissipating pad, is further higher than the tabletop since the heat-dissipating pad has a certain thickness, as shown in FIG. 1. As a result, the user's wrists must be maintained at a higher position for a long time and more strength must be applied while operating this notebook computer, resulting in ache and pain.

### SUMMARY OF THE INVENTION

Whereas the aforesaid conventional defects, a major object of the present invention is to disclose a storage-type heat-dissipating pad of a notebook computer that complies with human engineering and dissipates heat and that has convenient storage and carriage.

Concretely speaking, the heat-dissipating pad of the present invention has a storage body, which comprises a first storage chamber and a second storage chamber for storing computer peripherals such as computer mouse, battery, electrical wire, voltage regulator, portable disk, etc.

Moreover, the heat-dissipating pad of the present invention has a heat-dissipating body slanted at an angle. When the notebook computer is disposed on the heat-dissipating body for heat dissipation, the notebook computer is also slanted at a slanted angle. As a result, it is much handy to operate the notebook computer that complies with the human engineering. In addition, the heat-dissipating pad of the present invention is more labor-saving than conventional heat-dissipating pad.

### BRIEF DESCRIPTION OF THE DRAWINGS

FIG. 1 is a schematic view showing a conventional heat-dissipating pad having a notebook computer held thereon.

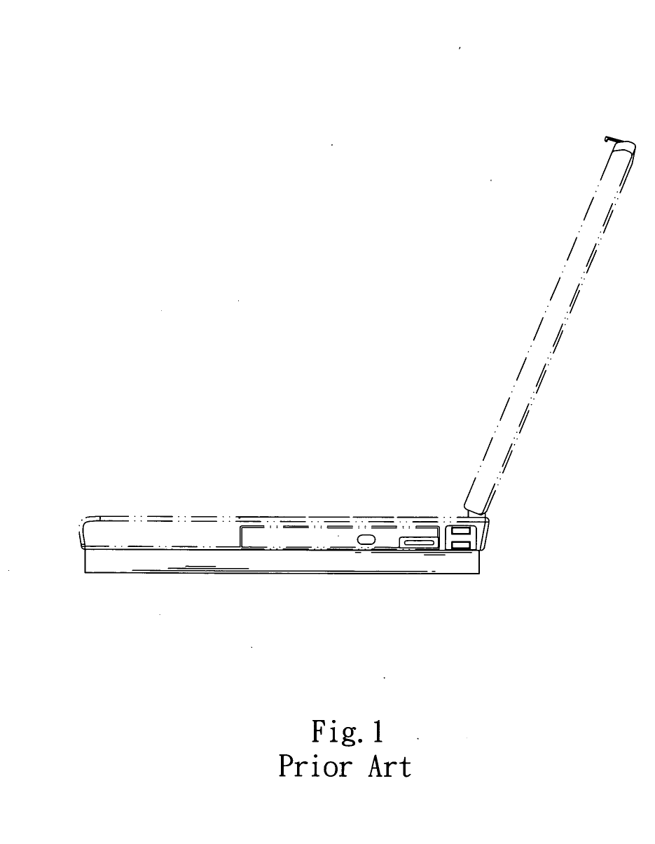

FIG. 2 is an elevational view showing a first preferred embodiment of the present invention.

FIG. 3 is an elevational view showing the first preferred embodiment of the present invention taken from another direction.

FIG. 4 is an elevational view showing a storage body and a heat-dissipating body of the first preferred embodiment of the present invention.

FIG. 5 is an elevational, exploded view showing the heat-dissipating body of the first preferred embodiment of the present invention.

FIG. 6 is a partial, cross-sectional view showing the first preferred embodiment of the present invention.

FIG. 7 is an elevational, enlarged view showing an encircled region A of FIG. 6.

FIG. 8 is a cross-sectional view showing the first preferred embodiment of the present invention.

FIG. 9 is a schematic view showing the storage body having computer peripherals stored therein according to the first preferred embodiment of the present invention.

FIG. 10 is a schematic view showing the heat-dissipating pad that holds a notebook computer according to the first preferred embodiment of the present invention.

FIG. 11 is a schematic view showing the operation of a second preferred embodiment of the present invention.

### DETAILED DESCRIPTION OF THE PREFERRED EMBODIMENT

Prior to description of the present invention, it is worth to note that the same reference characters indicate the similar parts in the following description.

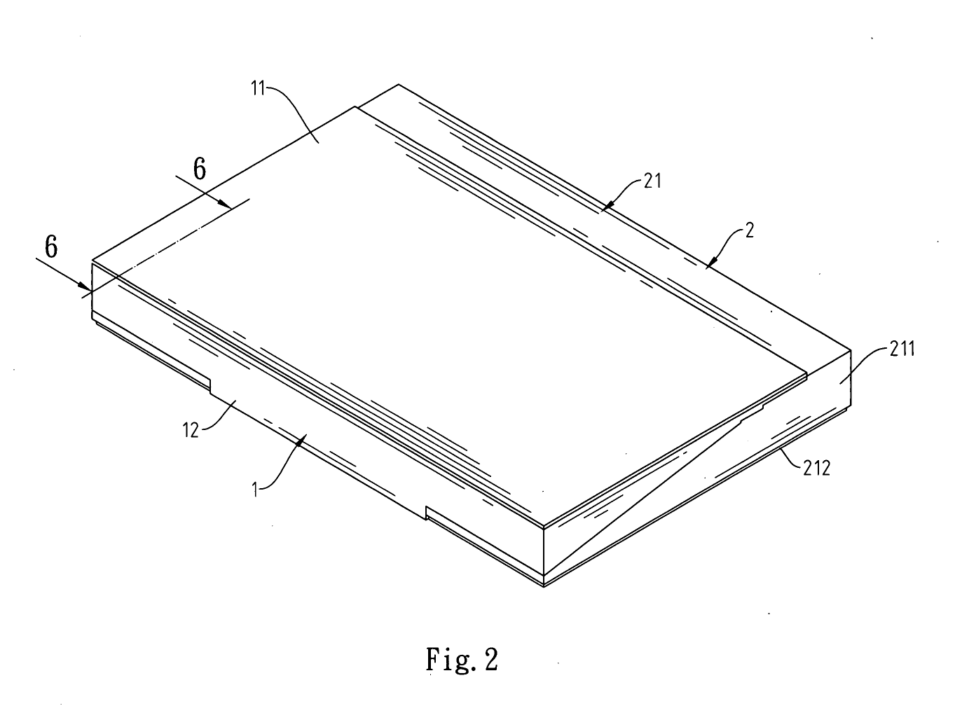

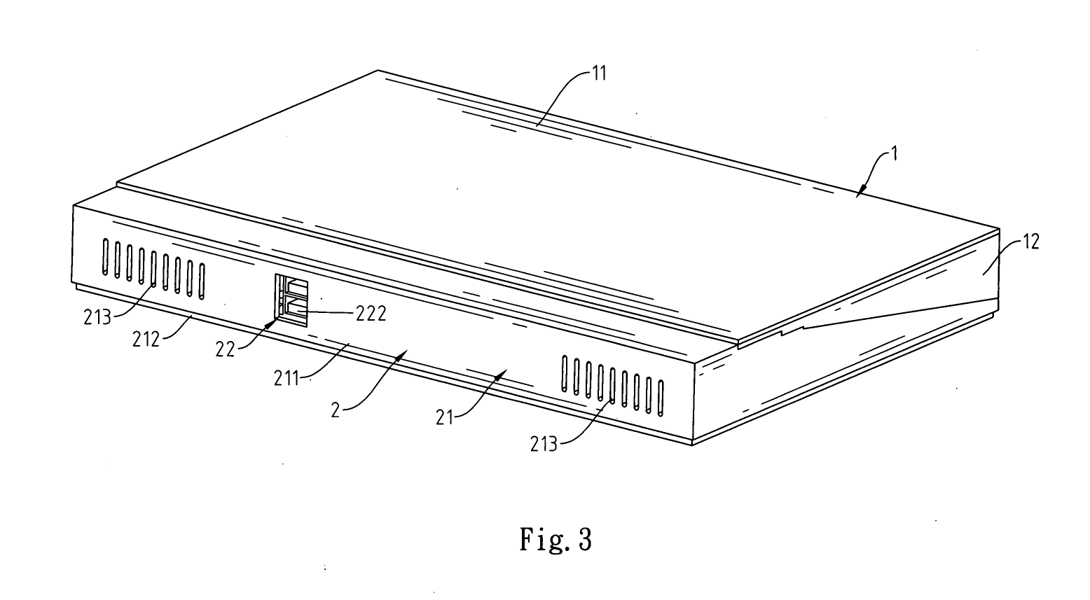

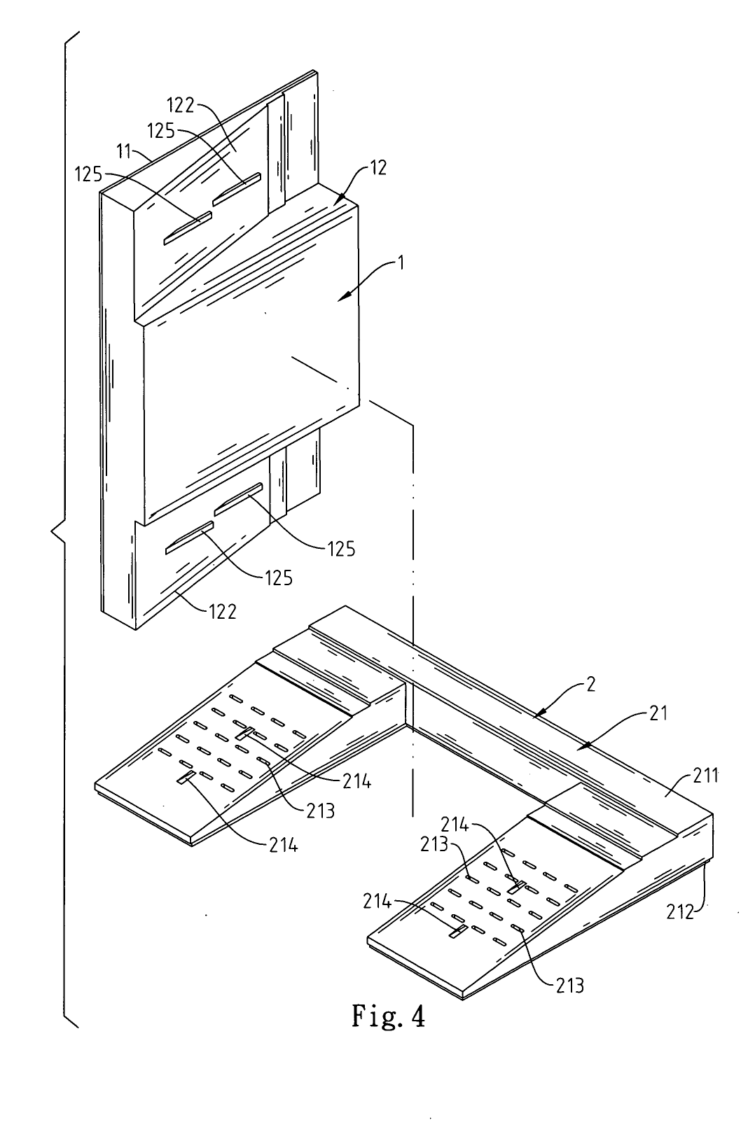

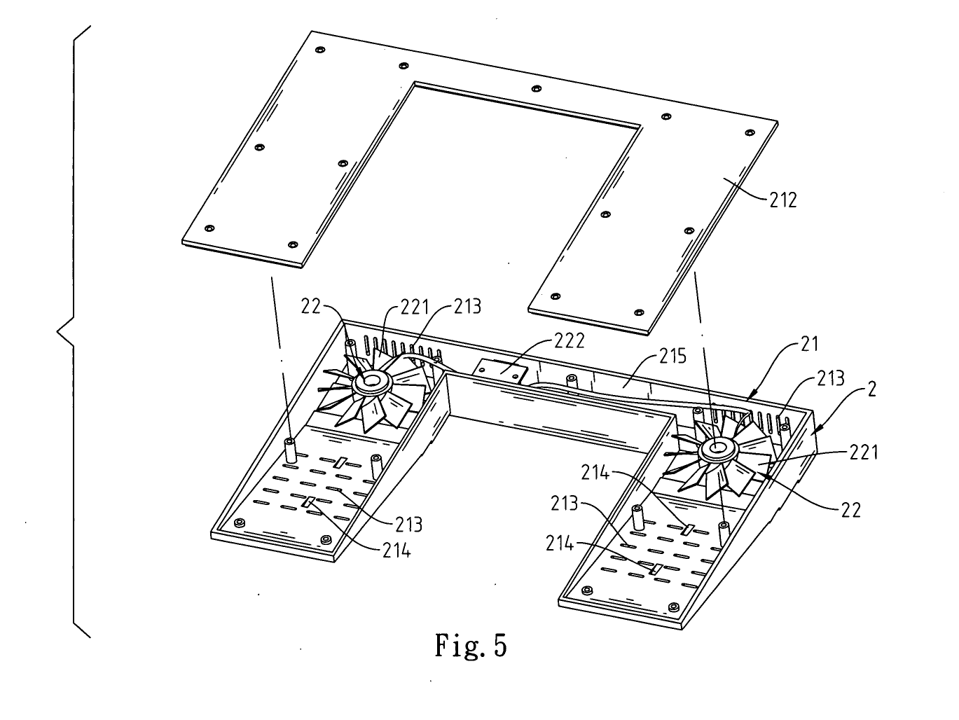

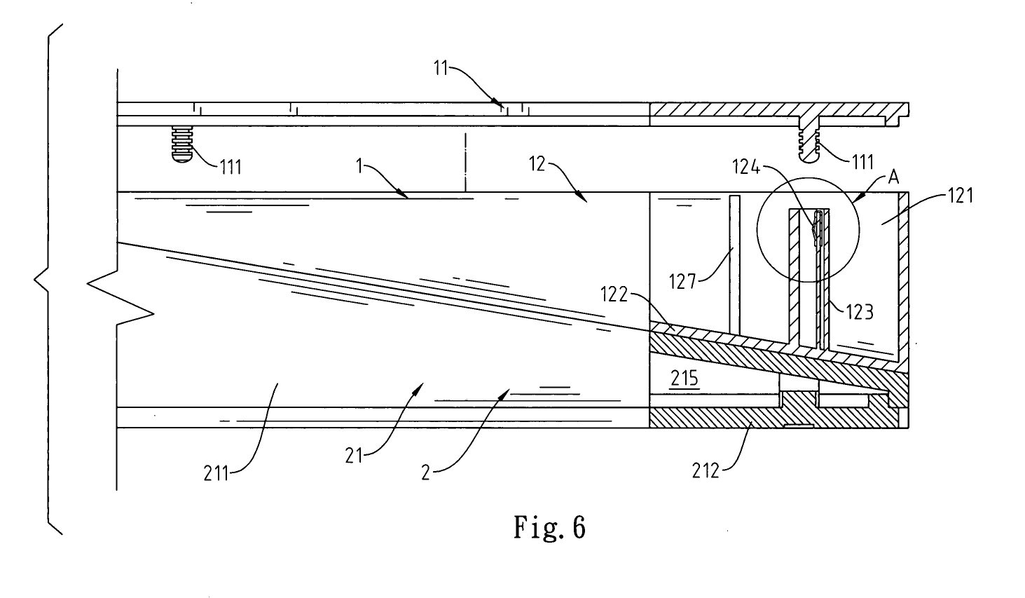

Referring to FIG. 2 through FIG. 7, a first preferred embodiment of the present invention is shown. A storage-type heat-dissipating pad of a notebook computer of the present invention comprises a storage body 1 and a heat-dissipating body 2.

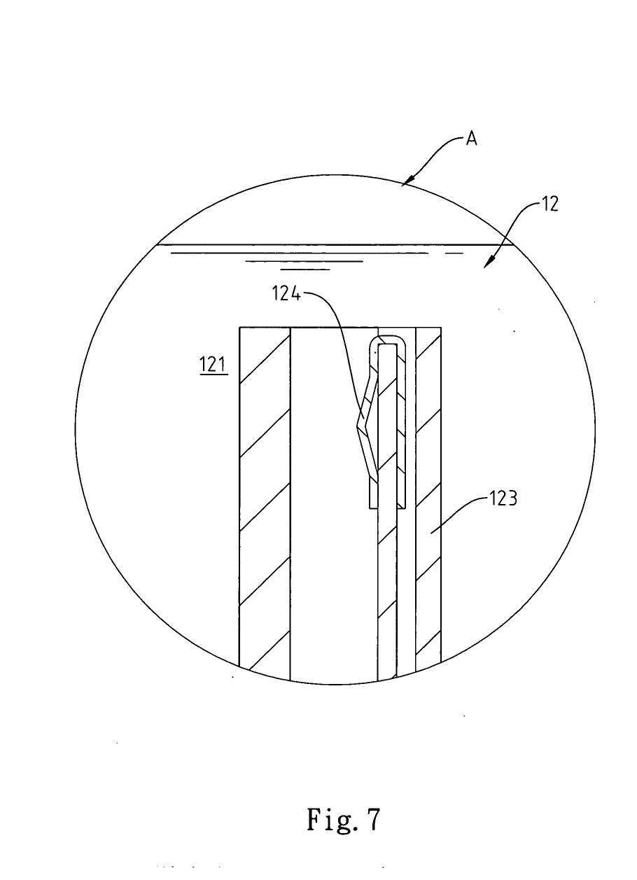

The storage body 1 comprises a cover 11 and a storage base 12. The cover 11 has several cylindrical pins 111 on one surface, wherein the cylindrical pins 111 have concave-convex multistage structures. The storage base 12 has a first storage chamber 121 on the center. The first storage chamber 121 has two bottom plates 122 bilaterally on the bottom at a slanted angle. Each of the bottom plates 122 has several coupling pillars 123 on the inner surface corresponding to the aforesaid pins 111. Each of the coupling pillars 123 has a resilience sheet 124 (shown in FIG. 7) disposed therein. In addition, each of the bottom plates 122 further has several insertion pins 125 on the opposite surface. Besides, a sunken second storage chamber 126 is formed between these two bottom plates 122. The second storage chamber 126 has two partition plates 127 fixed therein and each of the partition plates 127 has several notches 128.

The heat-dissipating body 2 comprises a shell 21 and a fan unit 22, wherein the shell 21 has an upper shell 211, a lower shell 212, several heat-dissipating openings 213, several insertion trenches 214 and a storage chamber 215. These heat-dissipating openings 213 are formed on the surface of the upper shell 211. These insertion trenches 214 are formed on the upper shell 211 corresponding to the aforesaid insertion pins 125. The upper shell 211 is assembled to the lower shell 212 for jointly defining the storage chamber 215. The aforesaid fan unit 22 is disposed in the storage chamber 215. The fan unit 22 has at lease one fan 221 and a power input terminal 222. The fan 221 is electrically connected to the power input terminal 222. The power input terminal 222 is, for example, a USB connector for connection with a USB slot (not shown) of the notebook computer.

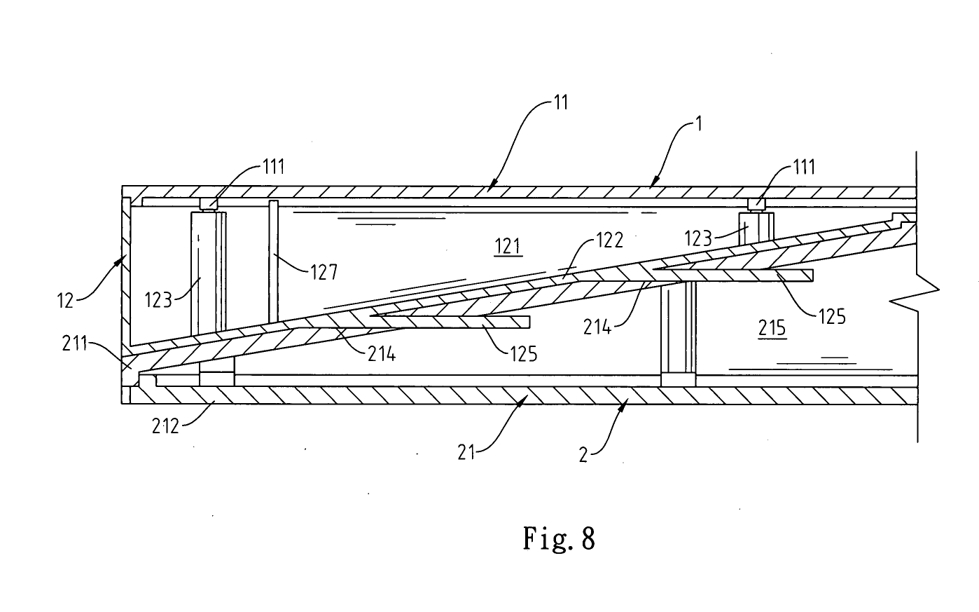

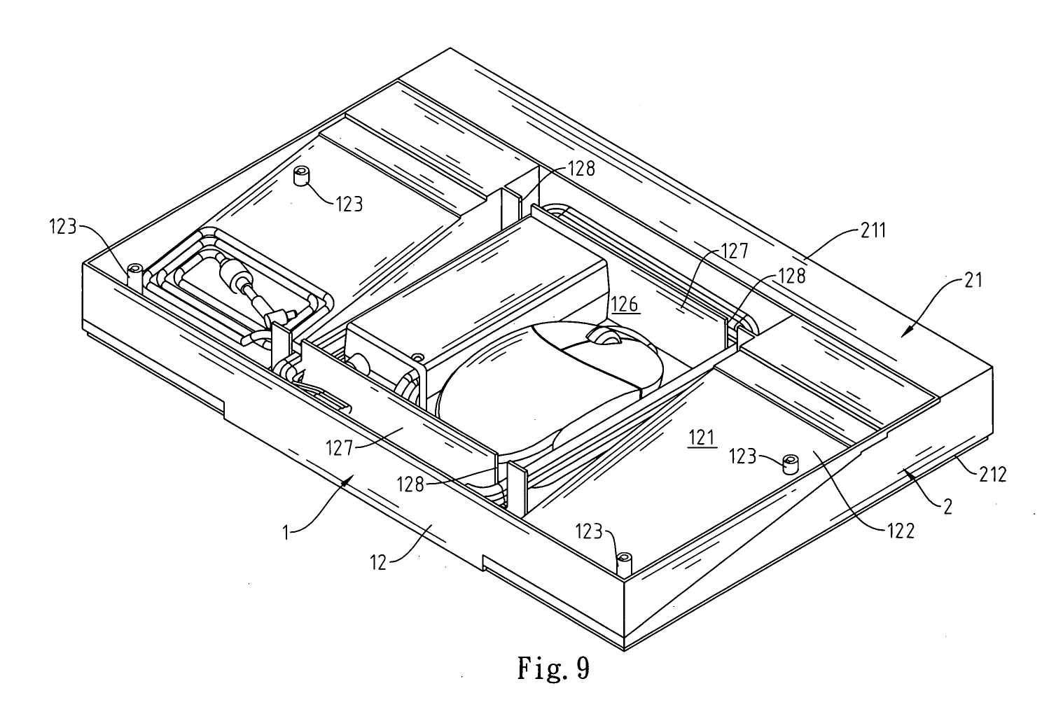

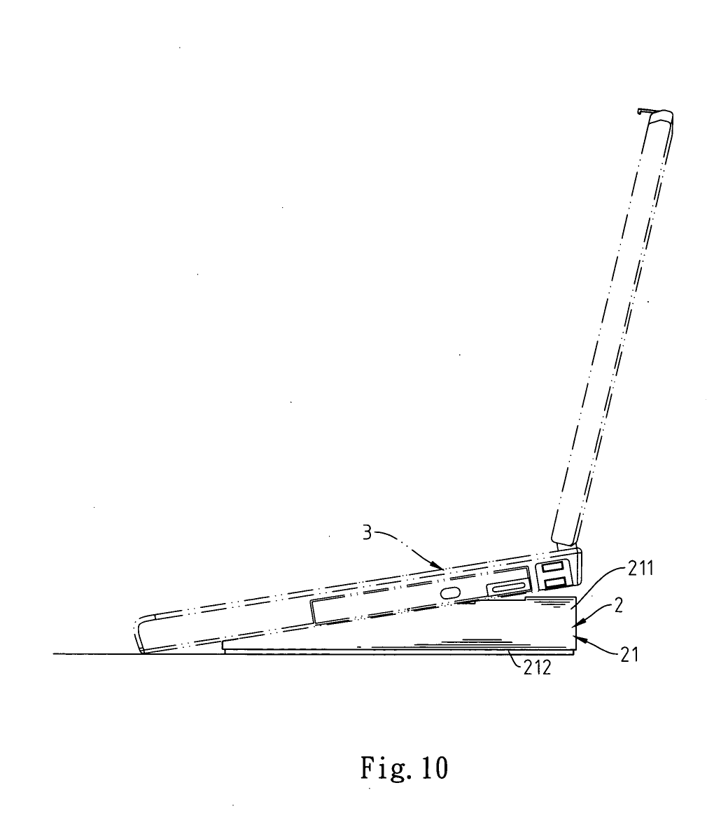

The assembled structure of the aforesaid components is shown in FIG. 8 to FIG. 10. In the storage-type heat-dissipating pad of the notebook computer of the present invention, the cover 11 is coupled with the storage base 12 by inserting the pins 111 into the coupling pillars 123, wherein the height of the assembled cover 11 and storage base 12 is adjustable by coupling the concave-convex multistage structures of the pins 111 with the resilience sheets 124. In addition, for the purpose of coupling the heat-dissipating body 2 with the storage body 1, the insertion pins 125 are inserted into the insertion trenches 214, respectively.

Referring to FIG. 7 and FIG. 8, the operation of the aforesaid components is shown. When the storage-type heat-dissipating pad of the notebook computer of the present invention is in use, the storage body 1 is detached from the heat-dissipating body 2 and disposed on the tabletop such that a computer mouse may be disposed on the cover 11 by treating this cover 11 as a mouse pad. In addition, the first storage chamber 121 and the second storage chamber 126 of the storage body 1 can be used for storing the computer peripherals such as computer mouse, battery, electrical wire, voltage regulator, portable disk, etc. Besides, after being wound around the outside of the coupling pillars 123, the electrical wire can be wound around the outside of the partition plates 127 and disposed in the notches 128 for storing the electrical wire effectively. In addition, the height of the cover 11 can be adjusted for storing the computer peripherals, which are higher than the first and second storage chambers 121 and 126, in the first and second storage chambers 121 and 126.

The aforesaid heat-dissipating body 2 is disposed on the tabletop, and the notebook computer 3 is disposed on the heat-dissipating body 2. The power input terminal 222 of the heat-dissipating body 2 is connected with a power terminal of the notebook computer 3 for rotating the fan 221 so as to dissipate the heat via the heat-dissipating openings 213.

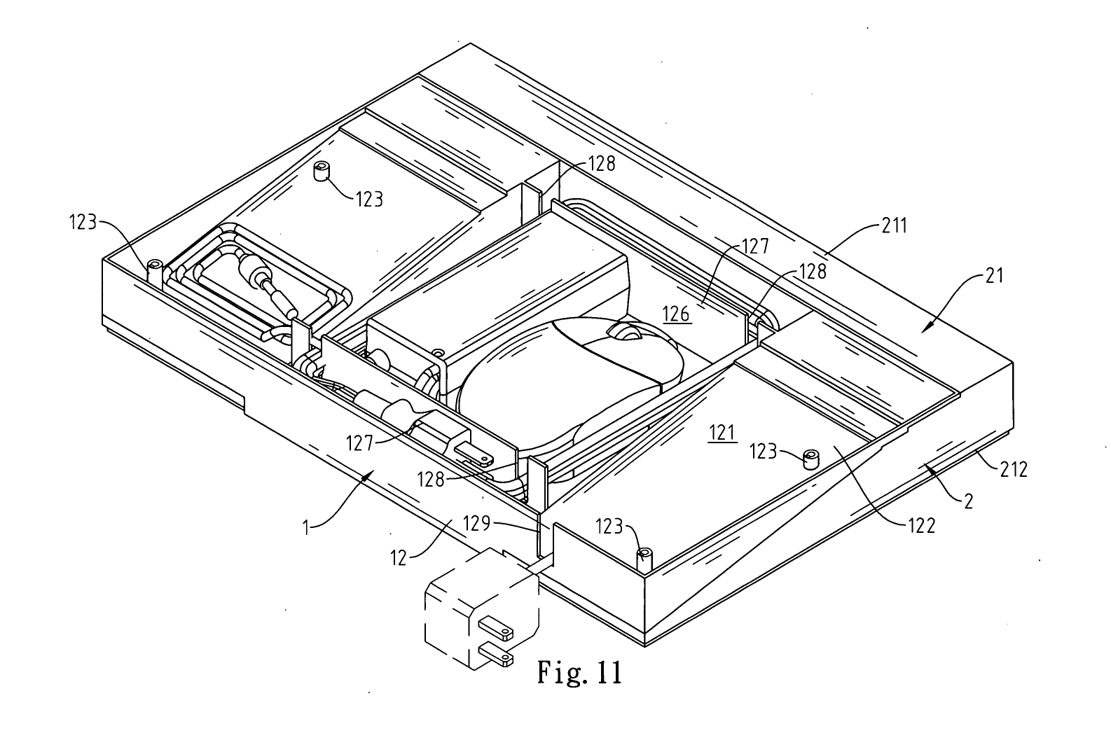

Referring to FIG. 11, a schematic view showing the operation of a second preferred embodiment of the present invention is shown, the difference between the second and first preferred embodiments is that a notch 129 is formed on one side of the storage base 12 of the storage body 1 of the second preferred embodiment for disposing a larger connector plug on the outside of the storage body 1.

What the invention claimed is:

1. A storage-type heat-dissipating pad of a notebook computer comprising:
a storage body comprising a cover and a storage base, said cover being coupled with said storage base, said storage base having a first storage chamber for storing a computer peripheral of said notebook computer; and
a heat-dissipating body for coupling with said storage body, said heat-dissipating body comprising a shell and a fan unit, said shell having an upper shell, a lower shell, a plurality of heat-dissipating openings and a storage chamber, said plurality of heat-dissipating openings being formed on a surface of said upper shell, said upper shell being assembled to said lower shell for jointly defining said storage chamber, said fan unit being disposed in said storage chamber, said fan unit having at lease one fan and a power input terminal for electrical connecting said fan with said power input terminal.

2. The storage-type heat-dissipating pad of a notebook computer of claim 1, wherein said storage base has a notch on one side thereof for disposing a larger connector plug on the outside of said storage body.

3. The storage-type heat-dissipating pad of a notebook computer of claim 1, wherein said power input terminal is a USB connector.

4. The storage-type heat-dissipating pad of a notebook computer of claim 1, said cover of said storage body having a plurality of cylindrical pins on one surface thereof, said plurality of cylindrical pins having a plurality of concave-convex multistage structures, said first storage chamber having two bottom plates bilaterally on the bottom thereof at a slanted angle, each of said bottom plates having a plurality of coupling pillars on an inner surface thereof corresponding to said plurality of cylindrical pins, each of said plurality of coupling pillars having a resilience sheet disposed therein, said plurality of cylindrical pins being coupled with said plurality of coupling pillars, respectively, for coupling said cover with said storage base, each of said bottom plates having a plurality of insertion pins on an opposite surface thereof, a sunken second storage chamber being formed between said two bottom plates, said second storage chamber having two partition plates fixed therein, and each of said partition plates having a plurality of notches.

5. The storage-type heat-dissipating pad of a notebook computer of claim 4, wherein said upper shell has a plurality of insertion trenches corresponding to said plurality of insertion pins for insertion thereinto.
